(19) United States
(12) Patent Application Publication
(10) Pub. No.: US 2007/0056803 A1
(43) Pub. Date: Mar. 15, 2007

(54) Stairlifts

(76) Inventors: Andreas C. Szentistvany, Hampshire (GB); Martyn J. Orriss, Hampshire (GB)

Correspondence Address: GRAY, PLANT, MOOTY, MOOTY & BENNETT, P.A., P.O. BOX 2906, MINNEAPOLIS, MN, 55402-0906, US

(21) Appl. No.: 10/566,309

(22) PCT Filed: Jul. 27, 2004
(86) PCT No.: PCT/GB04/03275

§ 371 Date: Jul. 21, 2006

(30) Foreign Application Priority Data
Jul. 28, 2003 (GB) 0317618.7

(51) Int. Cl. B66B 9/08

(52) U.S. Cl. 187/201

(57) ABSTRACT

The invention provides a swivel mechanism (10) for inclusion between the carriage (14and chair 12) of a stairlift. The mechanism preferably includes two pivot axes, each offset from the center line of the chair so as to reduce the rearward intrusion when the chair is swivelled. The swivel action is preferably effected by the interaction of control members (40a, 40b) sliding in inter-related arcuate guides (38a, 38b).

### FIELD OF THE INVENTION

This invention relates to stairlifts and, in particular, to a seat swivel mechanism for incorporation between the chair and carriage of a stairlift assembly.

### BACKGROUND TO THE INVENTION

It is known to provide a swivel mechanism on a stairlift to enable the chair to be swivelled about a substantially vertical axis. This enables the chair to be rotated at an end of the staircase in which the stairlift assembly is mounted, thus making it easier for a user to mount or dismount from the chair and, in particular, to avoid any obstruction caused by the presence of the footrest which forms part of the chair.

On many installations, provision is made to swivel the chair only at the top of the staircase. However, there is a demand for the chair to be capable of swivelling in both directions, thereby facilitating mounting and dismounting from the chair at both ends of the staircase. This demand presents a number of issues.

In order to accommodate swivelling in both directions on existing installations, the chair is pivoted at or close to its geometric centre. As the chair is swivelled, a significant part of the chair moves in a rearward arc and may collide with the wall of the staircase in which the assembly is mounted. To reduce the likelihood of interference with the wall, a number of solutions are currently adopted. Firstly, the pivot point of the chair may be repositioned on the carriage so that, when the stairlift is positioned in a staircase, the chair pivot is positioned further away from the wall. Secondly, the entire stairlift assembly may be positioned further away from the wall.

Whilst both of these solutions reduce the likelihood of interference with the wall, both result in the stairlift obstructing the staircase, to a greater extent, for able bodied users of the staircase.

A third approach is to reduce the width of the chair, or provide cut-outs in the chair, to reduce the size of the arc through which the extremities of the chair swing. This solution compromises the comfort of the user.

There are further issues with current two-way chair swivel arrangements. One issue is that there is some risk that the seat could be swivelled into a downwardly facing direction at the top of the staircase, thus subjecting a user to considerable danger. Another issue is that a powering mechanism included within the swivelling arrangement could fail making it awkward and even dangerous for the user to dismount from the chair.

It is an object of this invention to go at least some way in addressing the limitations of existing stairlift seat swivel mechanisms as described above; or which will at least provide a novel and useful choice.

### SUMMARY OF THE INVENTION

Accordingly, in a first aspect, the invention provides a swivel mechanism for incorporation between the carriage of a stairlift assembly, and a chair having a pair of spaced sides and a central axis midway between said spaced sides, said swivel mechanism being characterised in that it includes at least one pivot centre about which said chair may swivel with respect to said carriage, said pivot centre intersecting with said chair at a point between said central axis and one of said sides.

Preferably said swivel mechanism includes two pivot centres located so as to intersect with said chair on opposite sides of said central axis, said swivel mechanism being constructed and arranged so that only one pivot centre is engaged at one time to define the swivel axis between said chair and said carriage.

Preferably said swivel mechanism is further characterised in that the means for defining one of said pivot centres serves to limit the degree of rotation about the other of said pivot centres, when said other of said pivot centres is engaged to define said swivel axis.

Preferably said swivel mechanism includes an arcuate guide positioned to overlie each of said pivot centres.

Preferably said swivel mechanism further includes a control member mounted for rotation about each pivot centre, and being engageable with said guide, said guide being slidable with respect to its control member.

Preferably the swivel movement is generated by applying a rotating action to the control member mounted on a first of said pivot centres, against the edge of the guide in contact therewith, whilst allowing sliding movement of the other of said guides over the control member mounted on the other of said pivot centres.

Preferably said swivel mechanism further includes a motor for each said control member, each said motor being operable to rotate only the control member associated therewith.

Preferably interlock means is provided to cut power to one of said motors whilst the other of said motors is in operation.

Preferably said swivel mechanism further includes means to manually isolate said motor or motors from said control member or members.

In a second aspect the invention provides a stairlift assembly including the swivel mechanism as herein before set forth.

In a third aspect the invention provides a swivel mechanism including:

a substantially planar first part;

a substantially planar second part arranged substantially parallel to said first part, said first and second parts being capable of rotation with respect to one another about two spaced swivel axes arranged perpendicular to their planes,

said swivel mechanism being characterised in that the means which defines one of said swivel axes, when not so engaged as to act as the swivel axis, serves to control the relative motion of said first and second parts about the other of said swivel axes.

Preferably the rotation about each of said swivel axes is defined by the combination of arcuate guides provided in one of said first or second parts, and control members mounted on the other of said first or second parts, said control members engaging with, and being displaceable with respect to, said arcuate guides.

Preferably a control member is mounted on, and is pivotable about, each of said swivel axes.

In a fourth aspect the invention provides a swivel mechanism providing swivel actions about two spaced, parallel axes, said mechanism being characterised in that the swivel action about each axis is effected and controlled by the interaction of control members displaceable in respect to arcuate guides.

Preferably said control members are also rotatable.

Preferably said arcuate guides comprise slots in which said control members are received.

In a fifth aspect the invention provides a stairlift assembly including a carriage and a chair, wherein a swivel mechanism as defined above is disposed between said carriage and said chair.

In a sixth aspect the invention provides a swivel mechanism for a stairlift assembly having a carriage and a chair mounted on said carriage, such that said chair can be swivelled from central position in which a user seated in said chair faces in a direction substantially perpendicular to the direction of travel of said carriage, to first and second positions in clockwise and counter-clockwise directions, respectively, from said central position,

said swivel mechanism being characterised in that first drive means are provided to effect a swivel action between said central position and said first position; and second drive means are provided to effect a swivel action between said central position and said second position.

Preferably said swivel mechanism includes two spaced swivel axes such that said chair swivels between said central position and said first position about one of said axes, and between said central position and said second position about the other of said axes.

In a seventh aspect the invention provides a carriage/chair combination for a stairlift including the swivel mechanism set forth above.

In an eighth aspect the invention provides a swivel mechanism for incorporation between a stairlift carriage and a stairlift chair, said swivel mechanism including at least one motor to rotate said chair with respect to said carriage, said swivel mechanism being characterized in that manual disengagement means are provided to allow said motor to be disengaged thus allowing said chair to be manually rotated with respect to said carriage.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be determined by the appended claims alone.

### BRIEF DESCRIPTION OF THE DRAWINGS

One working embodiment of the invention will now be described with reference to the accompanying drawings in which:

FIG. 1: shows a front elevation of a stairlift assembly including a swivel mechanism according to the invention;

FIG. 2: shows a side elevation of that which is shown in FIG. 1;

FIG. 3: shows an enlarged side view of the swivel mechanism shown in FIG. 2;

FIG. 4: shows and end sectional view of that which is shown in FIG. 3;

FIG. 5: shows a view along the line V-V in FIG. 4 with some detail overlaid for clarity;

FIG. 6: shows a view along the line VI-VI in FIG. 4;

FIG. 7: shows a view similar to that shown in FIG. 6 but with the swivel mechanism actuated to swivel a stairlift chair in a counter-clockwise direction;

FIG. 8: shows a view, from below, of an alternative form of swivel mechanism according to the invention;

FIG. 9: shows an end view of that which is shown in FIG. 8; and

FIG. 10: shows an exploded view of some of the components included in the mechanism shown in FIGS. 8 & 9.

### DETAILED DESCRIPTION OF WORKING EMBODIMENT

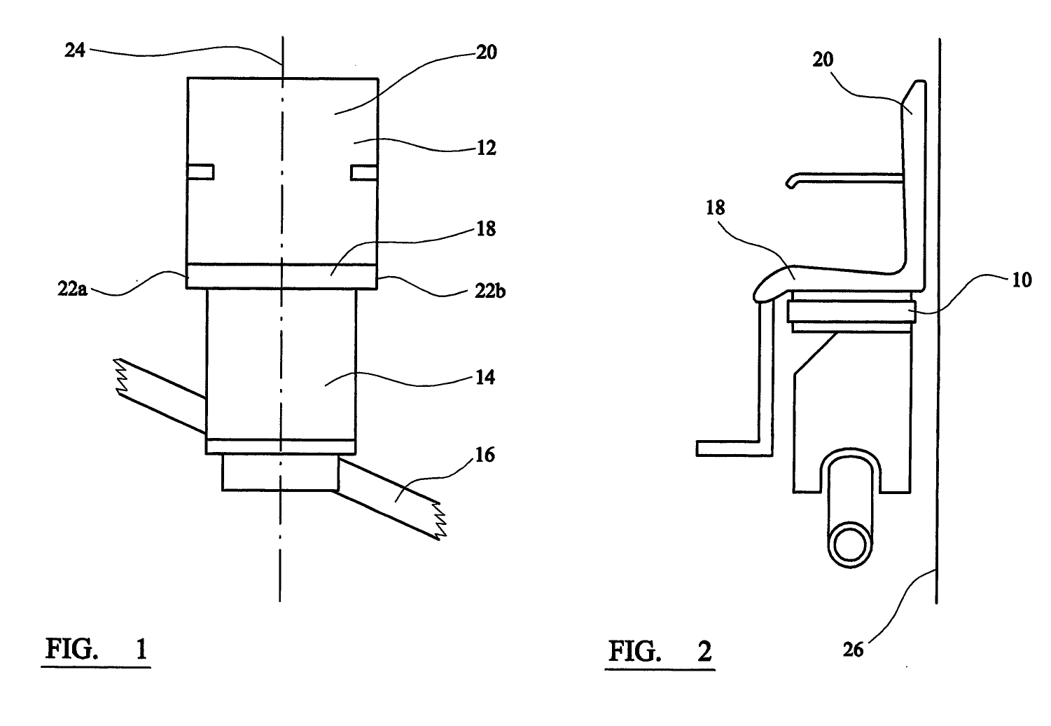

Referring firstly to FIGS. 1 and 2, according to the invention a swivel mechanism 10 (FIG. 2) is provided for incorporation between the chair 12 and carriage 14 of a stairlift assembly. In the conventional manner, the carriage 14 is mounted on, for movement along, a rail 16. A suitable motor and gearbox (not shown), mounted within the carriage 14, effects such movement.

Referring specifically to FIG. 1, the chair 12 has a seat base 18 and back rest 20. The seat base 18 has opposed side edges 22a and 22b and a centre line indicated by dotted line 24. Conventionally , when installations of this type are fitted with a chair swivel mechanism, the chair 12 pivots about the centre line 24. It will be appreciated, however, that upon swivelling of the chair 12 about a pivot axis on the centre line 24, one of the seat side edges 22a or 22b is displaced rearwardly and, if sufficient clearance is not provided, the edge will collide with the wall 26 (FIG. 2) defining that part of the staircase adjacent to which the stairlift is installed.

In the past two solutions have been used to address this problem. Firstly, the stairlift has been mounted a greater distance from the wall 26 to allow the full swivel action of the chair 20 to be accommodated. Alternatively, or in addition, the width of the chair 20 has been reduced to reduce the rear overhang of the chair when in the swiveled position.

In accordance with the present invention, the swivel mechanism 10 is provided with two pivot centres as will be described in greater detail below, each of the pivot centres being arranged between the chair centre line 24 and the outer edges 22a and 22b respectively. The swivel mechanism is constructed and arranged so that the chair swivels about that axis closest to the swivel direction and thus, that edge of the chair which, during swivelling, moves rearwardly is displaced rearwardly to a markedly lesser extent than would be the case if the chair swivelled about centre line 24.

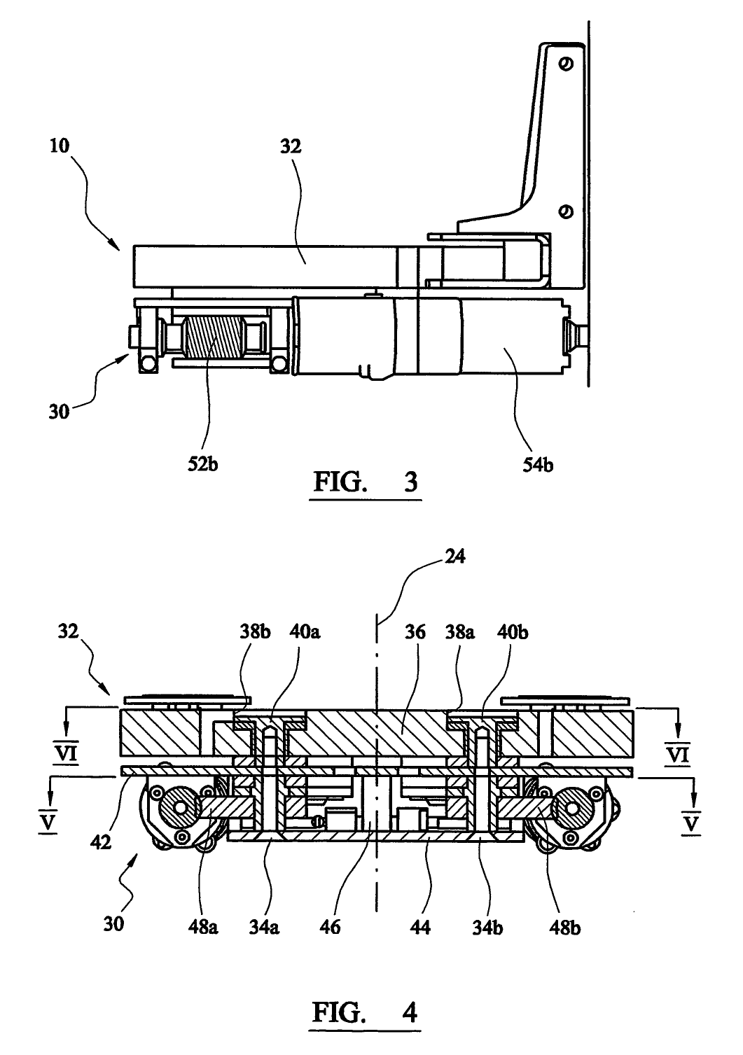

In the form shown herein, the swivel mechanism 10 includes a substantially planar base part 30 which attaches to the carriage 14, and a substantially planar swivel section 32 which attaches to the chair 20. As can be seen in FIGS. 4 to 7, the swivel mechanism 10 includes two pivot centres 34a and 34b, each of which intersects with the chair at points equidistant from the centre line 24 of the chair.

In the particular embodiment described herein the swivelling action is effected through the inter-relationship of guides and control members. This allows an extremely compact swivel mechanism as it is important that the additional height imposed by the inclusion of the swivel mechanism 10, is kept to a minimum.

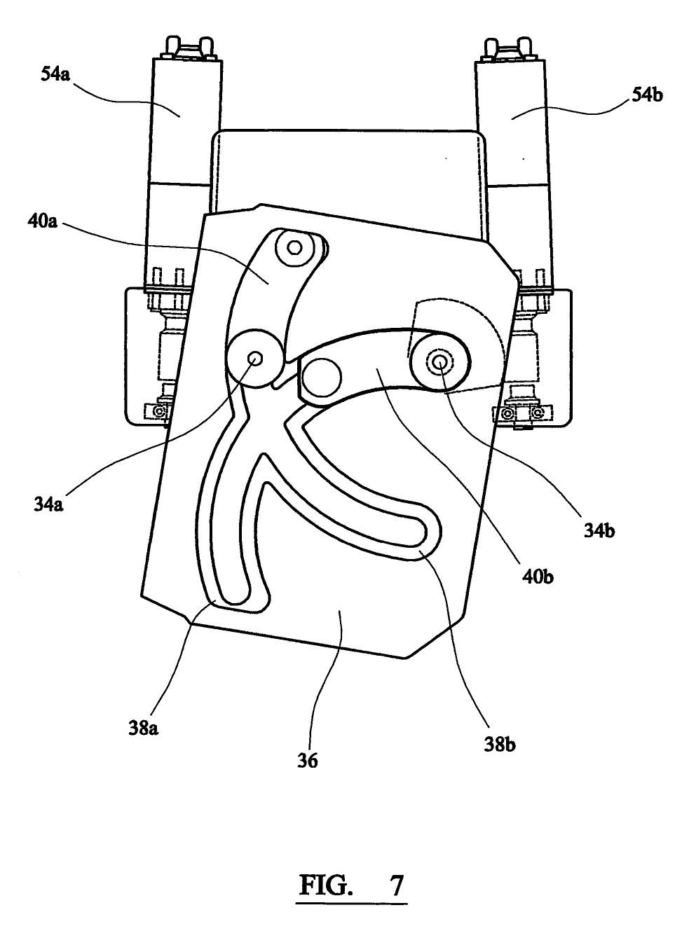

That part 32 of the swivel mechanism which is attached to, and moves with, the chair 20 includes a swivel block 36. As can best be seen from FIGS. 6 and 7, the swivel block 36 has formed therein a pair of arcuate guides preferably in the form of slots 38a and 38b. These guide slots cross over at the central axis 24 and it will be noted that part of guide 38a overlies pivot 34b at all times, whilst part of guide 38b overlies pivot 34a at all times.

Located within the guide slots 38a and 38b are a pair of control members 40a and 40b. Control member 40a is fixed to rotate about pivot centre 34a whilst control member 40b is fixed to rotate about pivot centre 34b. As can be seen, control member 40b is located in guide slot 38a and controls the movement of the swivel block 36 about pivot centre 34a. In a similar manner, control member 40a is located within guide slot 38b and controls the movement of swivel block 36 about pivot centre 34b.

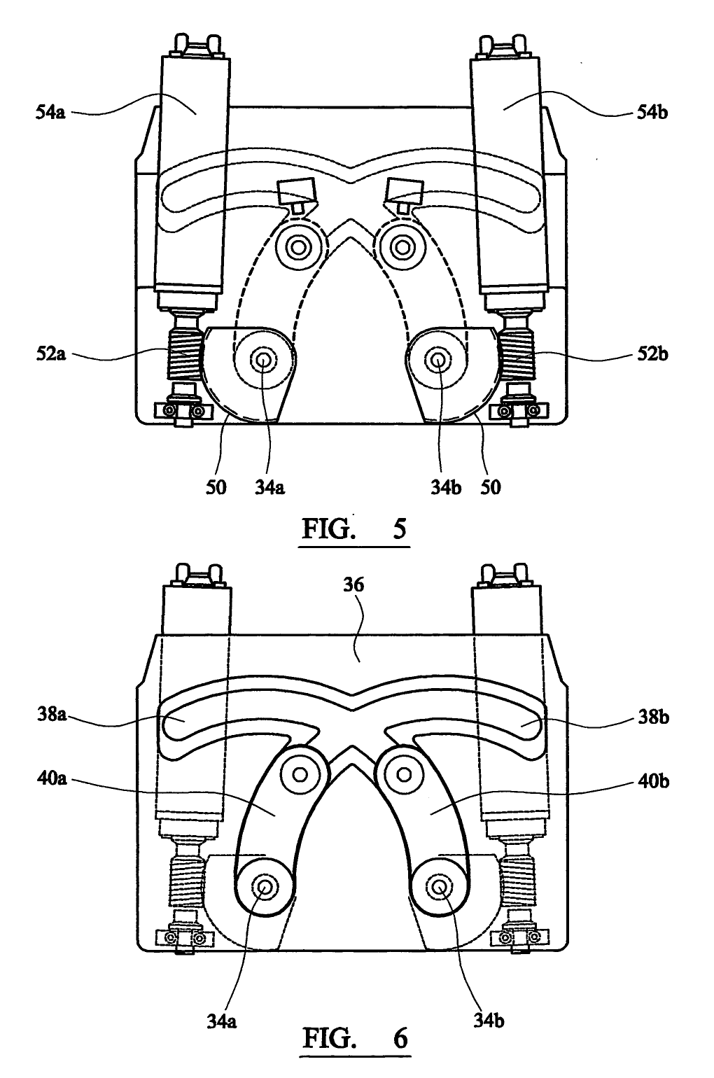

Turning to FIGS. 4 and 5, that section of the swivel mechanism 10 which is attached to the carriage 14 of the stairlift assembly includes an upper base plate 42 and a lower base plate 44 which are held in spaced relationship by spacers 46.

Sandwiched for rotation between the plates 42 and 44 are a pair of displacement members in the form of quadrant plates 48a, 48b. The quadrant plates are mounted to rotate about pins or shafts located on the pivot centres 34a, 34b and each has an arcuate edge 50 formed with suitable gear teeth. The rotational of each quadrant plate is splined to the respective control member 40a, 40b mounted there above. Thus, as quadrant plate 48a is rotated, so is control member 40a mounted there-above.

The geared edges 50 of the quadrant plates engage with worm drives 52 mounted on the output shafts of motor gearbox units 54. Thus, operation of the motor 54a causes rotation of quadrant plate 48a and, in turn, pivoting of control member 40a about pivot centre 34a. It will be appreciated, however, that other forms of drive could be used between the motors 54 and their respective control members.

When the chair 12 is in the central or operating position, the swivel mechanism is in the configuration shown in FIGS. 5 and 6. In this situation the control members are inwardly aligned which firmly locates and retains the swivel block locked in the position shown. Because of the resistance to movement imposed by the motors and gearing between the motors and their respective control members, the configuration is inherently stable.

Turning now to FIG. 7 the swivel mechanism is shown swivelled into the full counter-clockwise position. This is achieved by actuating motor gearbox 54b causing control member 40b to rotate from the central position in a counter-clockwise direction about pivot centre 34b. The action of the control member 40b against the side edges of arcuate slot 3 8a, causes the swivel block 36 to move in the counter-clockwise direction guided by the sliding relationship between arcuate slot 38b over control member 40a, which remains locked in position. The limit of movement of the swivel block 36 is reached when the free end of the control member 40a engages with the outer end of slot 38b.

To bring the swivel mechanism back to the central position, the motor 54b is reversed, and the block 36 moves in the clockwise direction until control member 40a engages the inner end of guide slot 38b.

Obviously, to rotate the chair from the central position in a clockwise direction, the control member 40a is rotated by motor 54a whilst the member 40b is maintained in the locked central position.

Suitable electrical interlocks are provided to ensure that, when one of the motors 54a or 54b is operating, the other is isolated. Furthermore, since each motor only serves to displace and return the swivel mechanism between the central position and one of either the clockwise or counter-clockwise positions, there is no risk of the swivel mechanism being powered through the central position and into a dangerous, wrongly aligned position, particularly at the upper end of the staircase.

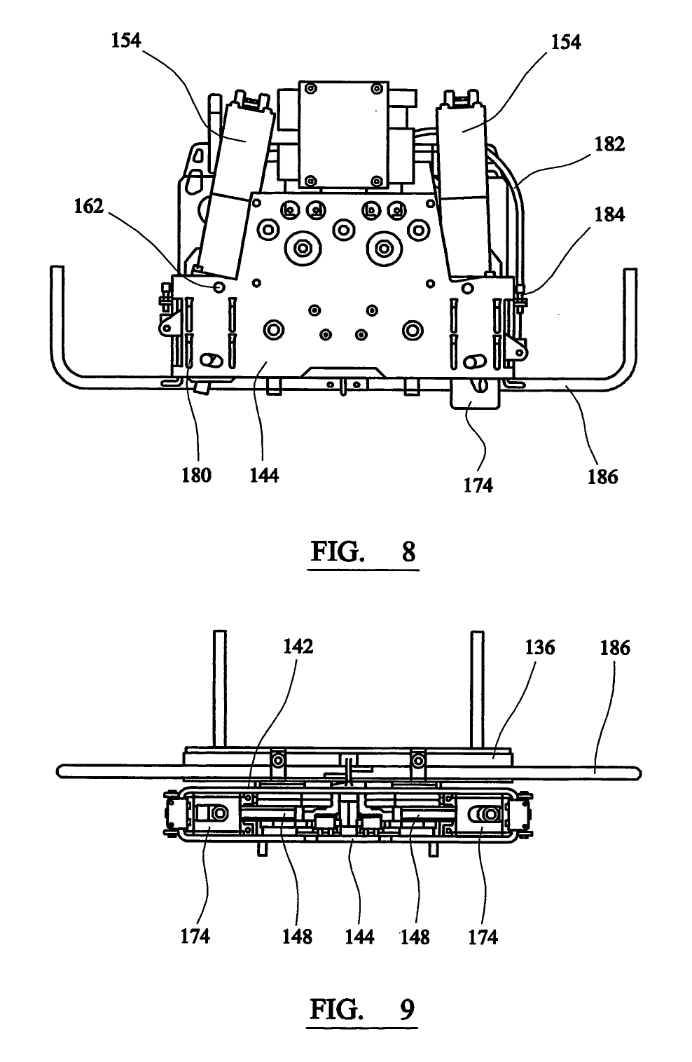

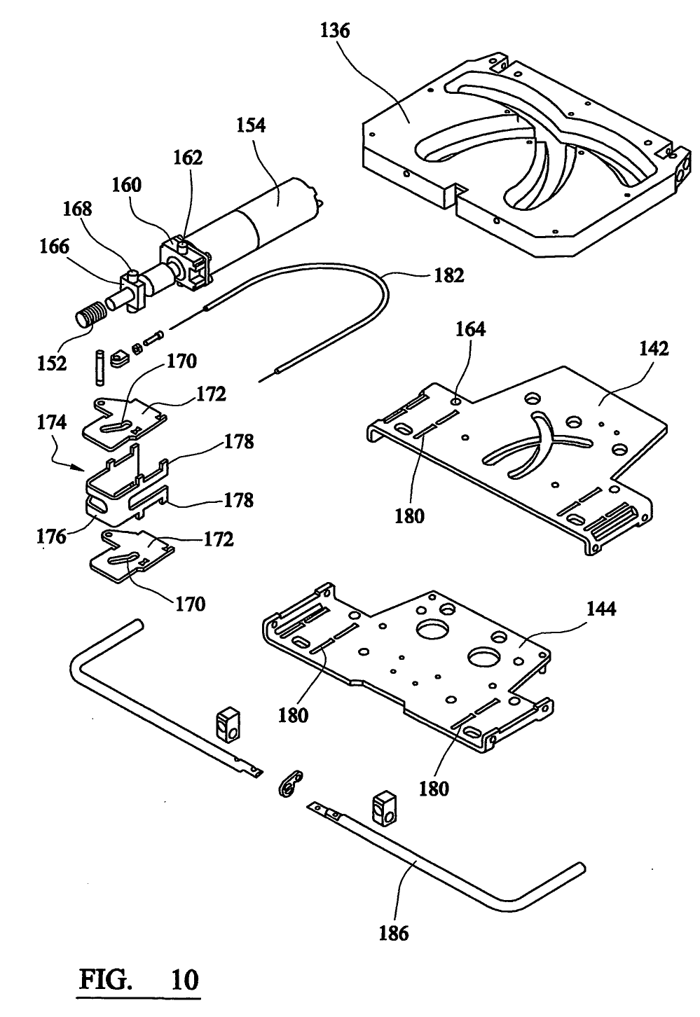

Turning now to FIGS. 8 to 10, it is preferred that the swivel mechanism as described above be provided with a facility that, in the event of any failure arising in the motor drive, allows the motor drive(s) to be manually dis-enabled and the chair returned to the central position, manually. In this way, the chair can be moved back into a position in which it is convenient and safe for a user to dismount from the stairlift.

The following description is directed to the motor drive on one side only of the swivel mechanism however it should be appreciated that the same configuration is applied to the drive on the opposite side of the swivel mechanism.

In the form shown herein, the motor gearbox unit 154 is displaceably mounted between upper base plate 142 and lower base plate 144. A manually operable linkage is provided to displace the motor gearbox unit and thus cause the same to be isolated from the swiveling function. This isolation is preferably effected by displacing the motor gearbox unit so as to disengage the worm drive 152 of the motor gearbox unit from the quadrant plate 148.

Displacement of the motor gearbox unit 154 is preferably effected by rotating the same thereby disengaging the teeth of the worm drive 152 from the toothed surface of quadrant plate 148. To this end, the motor gearbox unit is preferably mounted in a collar or yoke 160, the collar or yoke 160 having pivot spigots 162 projecting, along a common axis, from the top and bottom thereof. The spigots 162 engage in aligned holes 164 in the upper and lower base plates 142 and 144.

In order to effect and control rotation of the motor gearbox unit about the axis of spigots 162, a further collar 166 is fitted over the output shaft of motor gearbox unit 154 adjacent the worm drive 152. The output shaft of the motor gearbox unit 154 may freely rotate within the collar 166.

The collar 166 includes pivot spigots 168 projecting, on a common axis, from the top and bottom thereof, the spigots 168 engaging in aligned slots 170 formed in the upper and lower plates 172 of a sliding bracket 174. Sliding bracket 174 further includes a substantially U-shaped wall section 176 which holds the plates 172 in spaced, parallel, aligned relationship. As can be seen, tabs 178 project from the upper and lower edges of the side wall section 176. The tabs 178 serve to locate the plates 170 in relation to one another but project beyond plates 172 to engage in guiding slots 180 formed in the upper and lower base plates 142 and 144.

It will be appreciated that the engagement of tabs 178 in guiding slots 180 restricts the movement of the bracket 174 to sliding in a linear direction. However, because of the angled alignment of slots 172, as the bracket is displaced in a linear direction, the motor gearbox unit is caused to rotate about pivots 162.

In the form shown, displacement of the bracket 174 is effected by a Bowden cable 182 which extends between a stop 184 mounted on the upper plate 142/lower plate 144 assembly, and a release lever 186 pivotally mounted on the edge of the swivel block 136. By pivoting the lever 186 upwardly, the bracket 174 is displaced rearwardly thus drawing worm drive 152 out of contact with quadrant plate 148.

In operation, only one of the motor gearbox units is connected to release lever 186 at one time. The selected motor gear box unit 154 will be that which allows the chair to be rotated in an uphill direction only. To allow a user to manually displace the chair in a downhill direction is considered unsafe.

Whilst the preferred embodiments described herein include two pivot centres, some installations may only require swivel movement in one direction at the top of the staircase. In this event, essentially the same swivel mechanism would be provided however, only the most advantageous ‘active’ pivot would be selected, the remaining control member would be fixed in position, against rotation, and the motor 54 associated therewith, eliminated.

It will thus be appreciated that the present invention, at least in the case of the working embodiment described herein, provides a two way seat swivel mechanism for a stairlift which does not result in the stairlift assembly being further projected into the staircase and which does not compromise user comfort and safety. Further, the powered mechanism can be readily dis-enabled to allow the chair to be manually displaced from a position in which it may be causing an obstruction.

We claim:

1-21. (canceled)

22. A swivel mechanism for incorporation between a carriage of a stairlift assembly and a chair of the stairlift assembly, the chair having a pair of spaced sides and a central axis midway between the spaced sides, the swivel mechanism comprising: at least one pivot centre about which the chair may swivel with respect to the carriage, the pivot centre intersecting with the chair at a point between the central axis and one of the pair of spaced sides.

23. The mechanism of claim 22, in which there are two pivot centres located to intersect with the chair on opposite sides of the central axis, the swivel mechanism being constructed and arranged so that only one pivot centre at a time is engaged to define the swivel axis between the carriage and the chair.

24. The mechanism of claim 23, in which engagement of one of the pivot centres to define the swivel axis limits rotation about the other of the pivot centres.

25. The mechanism of claim 23, further comprising an arcuate guide positioned to overlie each of the pivot centres.

26. The mechanism of claim 25, further comprising a control member mounted for rotation on each of the pivot centres, and being engageable with a the guide, the guide being slidable with respect to its control member.

27. The mechanism of claim 26, in which a swivel movement is generated by applying a rotational action to the control member mounted on a first the of pivot centres, against and contacting an edge of the guide, while allowing sliding movement of the other of the guides over the control member mounted on the second of the pivot centres.

28. The mechanism of claim 26, further comprising a motor for each control member, each motor being operable to rotate its respective control member.

29. The mechanism of claim 28, further comprising interlocking means to disengage one of the motors while the other motor is in operation.

30. The mechanism of claim 28, further comprising means to manually isolate at least one motor from its respective control member.

31. The combination of the stairlift assembly and the swivel mechanism of claim 22.

32. A swivel mechanism, comprising a substantially planar first part; a substantially planar second part arranged substantially parallel to the first part, the first and second parts arranged for rotation with respect to each other about two spaced swivel axes perpendicular to each, and two respective means for defining the swivel axes; in which one means for defining a swivel axis, when not engaged to act as the swivel axis, controls relative rotation of the first and second parts about the other swivel axis.

33. The mechanism of claim 32, in which rotation about each swivel axis is defined by a combination of arcuate guides provided in one of the first or second parts, and control members mounted on the other of the first or second parts, the control members engaging with, and being displaceable with respect to, the arcuate guides.

34. The mechanism of claim 33, further comprising a control member mounted on and pivotable about respective swivel axes.

35. The combination of a stairlift installation including a carriage and a chair, and the swivel mechanism of claim 32 disposed between the carriage and the chair.

36. A swivel mechanism for providing swivel action about two spaced, parallel, axes, the mechanism comprising control members located in, and displaceable with respect to, arcuate guides, in which the swivel action about each axis is effected and controlled by the control members.

37. The mechanism of claim 36, in which the control members are rotatable.

38. The mechanism of claim 36, in which each arcuate guide comprises slots receiving the control members.

39. The combination of a stairlift installation including a carriage and a chair, and the swivel mechanism of claim 36 disposed between the carriage and the chair.

40. A swivel mechanism for a stairlift installation having a carriage and a chair mounted on the carriage, the chair being swivelable from a central position in which a user seated in the chair faces in a direction substantially perpendicular to the direction of travel of the carriage, to first and second positions in clockwise and a counter-clockwise directions, respectively, from the central position; in which the swivel mechanism comprises a first drive means to swivel the chair between the central position and the first position; and a second drive means to swivel the chair between the central position and the second position.

41. The mechanism of claim 40, in which the chair swivels between the central position and the first position about one spaced swivel axis and, between the central position and the second position about the other spaced swivel axis.

42. The combination of a carriage and chair for a stairlift and the swivel mechanism of claim 40.

43. A swivel mechanism for incorporation between a stairlift carriage and a stairlift chair, the swivel mechanism including at least one motor to rotate the chair with respect to the carriage, the swivel mechanism further comprising a means to manually disengage the swivel mechanism and thus allow the chair to be manually rotated with respect to the carriage.

44. The combination of a carriage and chair for a stairlift and the swivel mechanism of claim 43.
